(19) United States
(12) Patent Application Publication
(10) Pub. No.: US 2022/0002095 A1
(43) Pub. Date: Jan. 6, 2022

(54) System and Method for Reducing Environmental Contamination at a Material Transfer Point

(71) Applicants: Rosa Ester GUTIERREZ LEPE, Villa Alemana (CL); Natalia SEPULVEDA OLIVARES, Villa Alemana (CL); Alda, Mónica ACUÑA BARRIA, Villa Alemana (CL); Daniel SEPULVEDA GUTIEEEEZ, Villa Alemana (CL); Mariannela Ester SEPULVEDA GUTIEEEEZ, Villa Alemana (CL); Tatiana del Carneb SEPULVEDA GUTIEEEEZ, Villa Alemana (CL); Steven DIAZ SEPULVEDA, Villa Alemana (CL); Rodrigo OLIVARES ACUÑA, Villa Alemana (CL); Maria Elena OLEVARES JARA, Villa Alemana (CL); Ariel SEPULVEDA GUTIEEEEZ, Villa Alemana (CL); Aelsio MANRIQUEZ, Villa Alemana (CL); Felipe BAEZA DAROCH, Villa Alemana (CL); Eduth BARRIA BARRIA, Villa Alemana (CL); Claudio VILLEGAS, Villa Alemana (CL); María Ester JARA BARRERA, Villa Alemana (CL); Carlos GUTIEEEEZ LEPE, Villa Alemana (CL); Pedro PINO, Villa Alemana (CL)

(72) Inventor: David Ivan Sepulveda, Villa Alemana (CL)

(21) Appl. No.: 17/293,271

(22) PCT Filed: Dec. 3, 2018
(86) PCT No.: PCT/IB2018/059563

§ 371 Date: May 12, 2021

(51) Int. Cl. B65G 47/19; B65G 47/44; B65G 47/72; B65G 69/18; G01G 11/10; G01G 11/12

(52) U.S. Cl. CPC B65G 47/19; B65G 47/44; G01G 11/12; B65G 69/18; G01G 11/10; B65G 47/72

(57) ABSTRACT

Method and apparatus for the reduction of environmental pollution produced in material handling operations, especially but not exclusive in the transfer of material between two conveyor belts, one of material input and one of output of said material, are disclosed here. The pollution reduction mechanism is based on the reduction of the distance in free fall that the material travels from the material input conveyor belt, by means of maintaining live load of material inside the chute. To achieve this objective, the method considers: measuring the weight of the chute with material; the measurement of one of the two flows; the calculation of the rapidity of change of the weight of the chute; and the regulation of the mass flow of input to the chute or the regulation of the mass flow of output from the chute.

### TECHNICAL SECTOR

This invention relates to apparatus and methods for obtaining a stable filling level condition with live load of material into a chute at a material transfer point FIG. 2 and whose main objective is the reduction of the level of environmental pollution that is currently produced.

The preferred field of application is mineral processing plants and similar industries where there are material handling operations involving: a Chute; a source of material supply where said source of material supply may be a conveyor belt; and an apparatus that regulates the exit of said material from the chute where said apparatus can be another conveyor belt FIG. 1.

### Previous Technique

Regarding the existing solutions that are applied in the industry for this technical problem of environmental pollution are the following:

Wetting systems: These systems consist of wetting the material so that the finest particles of the material increase their weight, are applicable but in other material handling operations since the transfers of materials between conveyor belts are characterized by generating air currents with dust to the outside of the chute where these systems are not so effective.

Dust Collectors: Dust collectors are vacuum cleaners that suck air from inside the chute in order to produce a slight vacuum inside and thus prevent contaminated air from going outside the chute.

These equipment are more effective than the humidification systems for the application in question, however they are of high cost for both investment and operation in terms of energy consumption, since they require powerful air extractors and large spaces where the sleeve filters are housed, additionally they require of supply of compressed air the one that is used for the cleaning of the filters.

On the other hand, in the absence of a standard for its proper sizing, they are usually designed with low capacities that do not allow it to fulfill its objective efficiently due to an issue of investment and operating costs.

For their good performance they require that the openings between the inside of the Chute and the outside be very well sealed in order to achieve the required vacuum level.

Another problem of this equipment due to the fact that they work with cloth filters is that the fabrics in the presence of moisture and dust end up clogging and the cleaning system is not able to take off the “mud” that forms on its surface, decreasing thus its air suction capacity and therefore the production of vacuum needed inside the Chute.

Modified Chutes designs: Other solutions to this contamination problem refer to chutes designs, however these solutions improve the problem very slightly and basically consist in ensuring that the material does not travel directly from the material exit belt but rather through a kind of steps, they have the disadvantage that they favor the generation of clogging of the material with which this stops flowing.

### DISCLOSURE OF THE INVENTION

In one aspect of the present invention, apparatus for achieving a stable filling level with live load of material inside the chute is provided. The devices senses the level of live load of material in the inside of the chute and senses the material flow of one of the flows, either the input or the output of the chute material, the speed of change of the filling level of the material inside the chute, and this determines the adjustment that must be made on the flow to be regulated and that can be the input or output of the chute. A condition of stability of the level of filling of the chute is thus obtained.

In another aspect of the present invention, a method for achieving a stable filling level with live load of material inside the chute is provided. The method includes the steps of: sensing the level of live load of material inside the chute; the sensing of one of the material flows either the input or the output of the chute; the calculation of the rapidity of change of the level of filling of the chute and with this determines the adjustment that must be made on the flow of input or output of the chute. A condition of stability of the level of filling of the chute is thus obtained.

### BRIEF DESCRIPTION OF THE DRAWINGS

FIG. 1 The scheme shows the arrangement of the main parts at conventional material transfer point.

FIG. 2 The scheme shows the arrangement of the main parts at a material transfer point with the invention.

FIG. 3 The scheme shows the same as what FIG. 2 except that element 12 is this time a servo assisted actuator.

FIG. 4 This scheme shows an arrangement of conveyor belts in series where the last belt feeds a stock pile.

FIG. 5 This scheme shows an arrangement of conveyor belts and chute where the material comes from a stock pile and the final belt feeds a machine.

### BEST WAY TO CARRY OUT THE INVENTION

The following describes the method and devices that intervene distinguishing two different situations, the first one described is when the regulation and control of the level of filling of the chute is carried out through the regulation and control of the flow of material entering the chute and the second is when said level control is carried out through the regulation and control of the flow of material output from the chute. Note that when referring to the level of the Chute or the weight of the chute it is the same concept since both the weight of the material and its volume are related by the apparent density of the material that normally and for practical purposes is considered constant.

### Level Control Through the Control of Inputting Mass Flow

This case occurs when the chute outgoing belt feeds a machine FIG. 5, such as a crusher or a mill, in which the output flow of the chute is determined by the treatment capacity of the machine, whereby the level control of the chute must be carried out through regulation and control of the input flow to the chute. In this case, the material entry belt to the chute must be configured in such a way that it is possible to achieve that the mass flow of said belt is linearly proportional to the speed of said belt, unless there is a weight meter on said belt that allows know the load per meter of belt that carries said belt.

The ideal configuration is when the belt of entrance to the chute, where the exit belt of said chute feeds a machine, is when the input belt has a constant load per meter of belt which is feasible to be achieved.

As mentioned above, the invention consists in ensuring that the chute contains a certain amount of live load of material in its interior 17 FIG. 2 permanently and that this amount is maximum so as to minimize the height in free fall of the material H 19 inside the chute. For the fulfillment of this objective, a system for measuring the weight of the material inside the chute is incorporated into the chute, said system consists of the arrangement of weight sensors 10 of FIG. 2 on the chute support brackets so that the chute weight is supported on said sensors.

In addition to the above, a device called a frequency inverter is incorporated into the motor that drives the material input belt to the chute so as to be able to regulate the speed of the belt “Ve” in order to regulate the mass flow “Me” for which In addition, a speed sensor is incorporated into said belt.

Another element of the system is an electronic controller called PLC or a PID controller which receives the chute weight signal and the material input belt speed signal to the chute and based on an adjusted chute weight value “Pp (set point)” and at an allowable variation range defined by a lower limit “Lir” and an upper limit “Lsr” of the range, controls the speed of the belt “Ve” to control the mass flow of material input to the chute and thus control the level of filling of the chute.

Regarding the calculation of the difference in flows between the “Me” input and the “Ms” material output, this is obtained from the variable of rapidity of change of the level of filling of the chute, where this variable is obtained from of the definition of derivative of weight with respect to time, such as:

dP/dt=lim (when delta t tends to zero) of (P(t+delta t)−P(t))/delta t

where:

dP/dt=Me−Ms

It is recommended to use a delta t not so small, such as a second.

In this way it is possible to have the information of rapidity of change of the dP/dt filling level almost instantaneously.

The input flow Me is obtained from the speed of the input belt Ve and the constant of proportionality Kmve between the mass input flow and the speed of the input belt, whereby:

Me=Ve*Kmve

Where the Kmve can be obtained by capacity, that is to say a field measurement of the amount of material there is in a one meter of belt, the units of the Kmve are kg/m.

Another option that can be used for the calculation of the Kmve is the measurement of the speed of the input belt Ve and the measurement of the mass inlet flow Me of material to the chute, which can be measured through stopping for a brief time interval of the material output belt from the chute whereby the dP/dt is equal to the mass input flow Me, since the dP/dt is equal to the difference between the mass input flow minus the output mass flow and since in this situation of the stopped output belt the Ms is equal to zero then the dP/dt is equal to the mass input flow Me.

Kmve=Me/Ve

With this procedure to obtain the Kmve it is possible to continuously check its value and it can be done automatically.

Another advantage of this procedure is that it allows the operation of the plant to vary the load of the belt either to increase it or to reduce it for the purpose of operating with slower or faster belt speeds respectively, in which case the system of Kmve measurement will detect this condition and calculate its new value.

As for the material outflow, it can be obtained from the following relationship:

Ms=Me−dP/dt, since:

dP/dt=Me−Ms

It is also possible to obtain the output flow Ms from the speed of the output belt Vs and the constant of proportionality Kmvs between the mass output flow and the speed of the output belt, only when the chute fill level is above a certain value that guarantees that the mass flow is linearly proportional to the speed of the belt.

With respect to the Kmvs, this is obtained by a procedure similar to that applied to obtain the Kmve, with the exception that the belt that stops for a short time is this time the material entry belt to the chute.

Regarding the regulation and adjustment of the speed of the belt of entry of material to the chute Ve this is done through the regulation and adjustment of the rpm of the motor Ne that drives said belt, where the relationship between both variables is:

Ne=Ve*Knve

Where Knve is the constant of proportionality between the rpm of the motor Ne and the speed of the input belt Ve of material to the chute, where the constant Knve can be obtained from: the speed signal Ve and the signal of Ne by means of the incorporation of an motor rpm sensor, which:

Knve=Ne/Ve

As for the chute level control procedure acting on the regulation and control of the incoming mass flow Me, it consists of the following stages:

Parameter definition: Weight programmed to keep constant inside the chute Pp (Set Point); permissible range of variation with respect to Pp defined by a lower limit Lir and an upper limit Lsr; and time “ta” for corrections.

Receipt of the weight information of the chute P(t) and the speed of the material input belt to the chute Ve and optionally of the output speed Vs.

Calculation of the material inlet flow to the chute Me from the speed of the material inlet belt to the chute Ve and the proportionality constant Kmve between the flow of incoming material Me and the speed of the belt Ve, that is:

Me=Ve*Kmve

Calculation of the rapidity of change of the level of filling of the chute dP/dt from the definition of derivative mentioned above considering an appropriate delta t according to the precision of the chute weight measurement system.

Calculation of the output flow of chute material as:

Ms=Me−dP/dt

Determine if the current weight P(t) is outside the acceptable weight range, that is, if P(t)<Lir or P(t)>Lsr, if it is not out of range, it returns to the beginning of the procedure and if it is outside Proceed as explained below:

Calculation of the weight difference DP between the current weight P(t) and the programmed adjustment weight Pp (Set Point).

DP=P(t)−Pp

Calculation of dP/dt to correct dP/dt,c as:

dP/dt,c=−DP/ta

where ta is a scheduled time for adjustment.

Calculation of the input mass flow to be corrected Me,c based on the mass output flow Ms and the speed of change of the weight of the chute to be corrected dP/dt,c.

Me,c=Ms+dP/dt,c

Calculation of the new input belt speed to be corrected Ve,c from the mass input flow to be corrected and the proportionality constant Kmve.

Ve,c=Me,c/Kmve

Calculation of the rpm of the material input belt motor to the chute to be corrected Ne,c from the speed of the material input belt to be corrected Ve,c and of the Knve proportionality constant between the rpm of the motor Ne and the belt speed of the material input Ve to the chute.

Ne,c=Ve,c*Knve

Change of motor rpm through the motor frequency inverter during the time interval ta.

The corresponding calculation is then made to bring the motor rpm of the material input belt to the chute to the condition of mass input flow equal to mass output flow.

The level control procedure is repeated

### Level Control Through the Outgoing Mass Flow Control

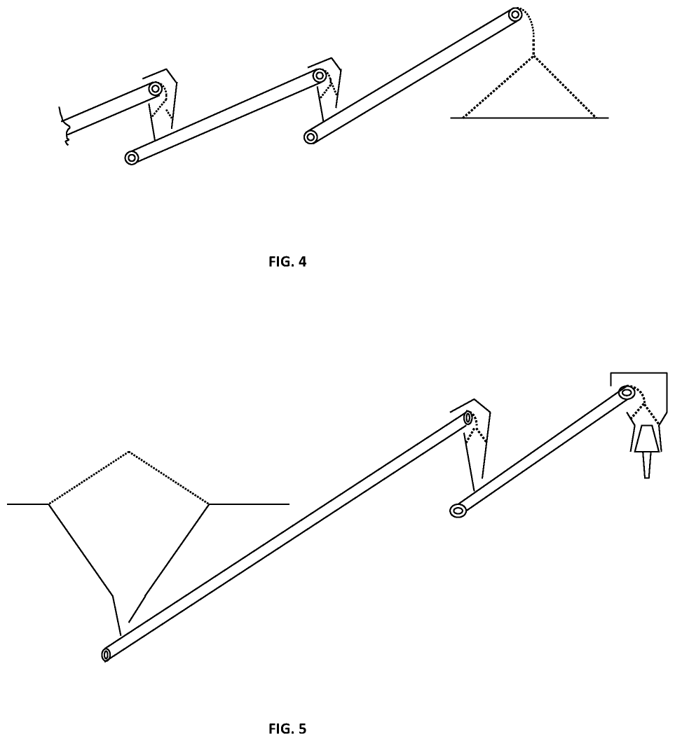

This type of control must be carried out when the chute material exit conveyor belt feeds a stock of material, FIG. 4, such as a stock pile and when the chute feed belt comes from the exit of a machine such as a crusher, in this case the feed flow is defined by the treatment capacity of the machine with which the adjustment Chute level should be done by regulating and controlling the mass flow of chute output.

The procedure in this case is very similar to the level control procedure through the control of the incoming flow, with which reference will be made in some cases to what is described above:

As the level control in this case is carried out by controlling the output flow of material Ms from the chute then it is the output belt that must be equipped with a frequency inverter for speed control Vs and a speed sensor of said belt.

there is also the option that the regulation and control of the outflow is carried out by means of a gate located at the outlet of the chute that has an actuator and position indicator that can be commanded and controlled remotely instead of using the option to regulate rpm of the output belt. As for the procedure described below, it is very similar to the procedure that would be used if a gate was used instead of a frequency converter.

The signal received by the PLC this time is the speed signal of the material output belt and the chute weight signal and control is performed on said belt, notwithstanding that it can also receive the belt speed signal of material input to the chute.

The mass flow of material Ms is obtained from the speed of the output belt Vs and the constant of proportionality Kmvs between the mass output flow and the speed of the output belt Vs, whereby:

Ms=Vs*Kmvs

Where previously mentioned ways to obtain the Kmvs.

The material input flow can be obtained from the relationship:

Me=Ms+dP/dt

As for the input flow Me it would not be able to obtain from the constant Kmve and the speed of the input belt Ve, since the flow of material Me is not necessarily proportional to the speed of the belt Ve.

As for the rpm of the Ns motor of the material output belt, the ratio is as follows:

Ns=Vs*Knvs

As in the previous procedure, the Knvs can be obtained in the same way described above.

As for the chute level control procedure acting on the outgoing flow, it consists of the following stages:

Parameter definition: Weight programmed to keep constant inside the chute Pp (Set Point); permissible range of variation with respect to Pp defined by a lower limit Lir and an upper limit Lsr; “ta” time for corrections.

Receipt of the information of the chute weight P(t) and the speed of the output belt Vs.

Calculation of the output flow of the chute Ms from the speed of the output belt Vs and the proportionality constant Kmvs between the output flow Ms and the speed of the output belt Vs, i.e.:

Ms=Vs*Kmvs

Calculation of dP/dt, as indicated above.

Calculation of the input flow of material to the chute as:

Me=Ms+dP/dt

Determine if the current weight P(t) is outside the acceptable weight range, that is, if P(t)<Lir or P (t)>Lsr, if it is not outside the range, it returns to the beginning of the procedure and if it is outside proceed as explained below:

Calculation of the DP as mentioned above.

Calculation of dP/dt to correct dP/dt,c as:

dP/dt,c=−DP/ta

where “ta” is a scheduled time for adjustment.

Calculation of the output flow to be corrected Ms,c based on the input mass flow and the speed of change of the weight of the chute to be corrected dP/dt,c

Ms,c=Me−dP/dt,c

Where Me=Ms+dP/dt

Calculation of the new belt output speed to be corrected Vs,c from the mass output flow to be corrected Ms,c and the proportionality constant Kmvs between the mass output flow Ms and the speed of the output belt Vs.

Vs,c=Ms,c/Kmvs

Calculation of the rpm of the motor of the output belt to be corrected Ns,c from the speed of the output belt to be corrected Vs,c and of the constant of proportionality Knvs between the rpm of the motor Ns and the speed of the output belt Vs.

Ns,c=Vs,c*Knvs

Change of the rpm of the motor through the frequency converter of the motor during the time interval “ta”.

The corresponding calculation is then made to bring the motor rpm of the output belt to the mass output flow condition equal to the mass input flow.

The level control procedure is repeated.

### INDUSTRIAL APPLICATION

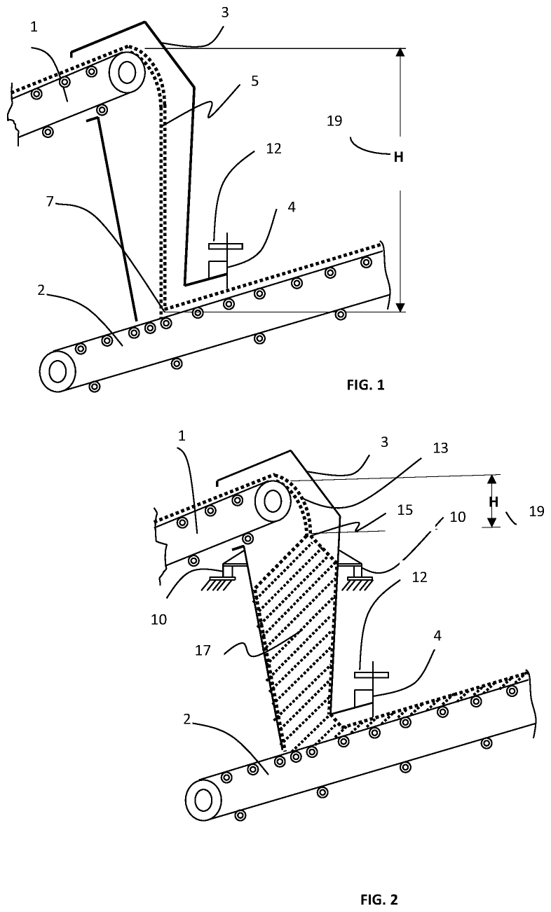

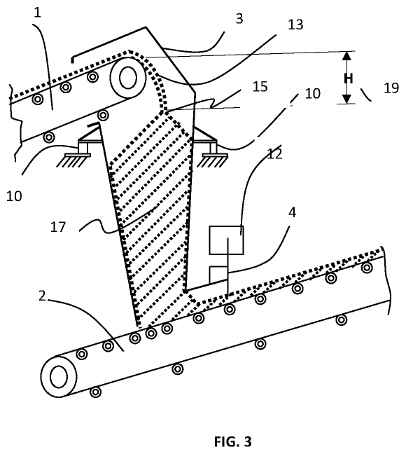

The preferred field of application is mineral processing plants and similar industries where there are operations of handling of materials in which they take part: a chute; a source of material supply where said source of material supply may be a conveyor belt; and an apparatus that regulates the exit of said material from the chute where said apparatus can be another conveyor belt FIG. 1.

The main technical problem that it solves refers to the great environmental pollution produced by these material transfer operations partly due to the extensive height in free fall that runs through the material inside the chute, where said contamination is air with suspended dust that when being breathed by people produces diseases of different kinds such as Silicosis, in addition to the problem of pollution there is also the problem of high energy costs, inputs and maintenance of the systems used to mitigate environmental pollution and in the present date have not solved the problem satisfactorily.

The aim of the invention is to provide a method and apparatus that allow the chute to permanently maintain a level of filling with live load of material as high as possible, FIG. 2 so that the material entering the chute falls on material and not on the internal walls of the chute or on the material exit conveyor belt.

This results in that the free fall height of the material H19 of FIG. 2 that enters the chute is smaller, which leads to the amount of air with suspended dust generated being reduced and where the amount of air with suspended dust generated with the chute with invention will be proportional to the drop height H19 FIG. 2 divided by the height of fall H19 of FIG. 1 times the amount of air with dust generated with a conventional chute. In other words, significant reductions in the generation of air with suspended dust can be achieved with the consequent savings in dust collectors in terms of their size, energy consumed, and maintenance costs and with the consequent improvement of environmental conditions.

Another technical problem is the energy consumption that could be avoided with the invention in conveyor belts for the output of chutes and whose final destination is a stock FIG. 4 since these belts must operate permanently at speeds such that they can transport the maximum mass flows of material that occur upstream, and when the fluxes go down they continue to operate at those same speeds since it is not possible to predict at what moment the maximums will occur flow.

In addition to this problem and derived from it, it is not possible to measure with good precision the mass flows of ore due to the flow fluctuations inherent in the process, for example crushing and which is also solved with the invention, since the loading of mineral that comes out of the chute expressed for example in kg/m remains constant and allows to calculate the mass flow of output with the single measurement of the speed of the output belt and with the constant of proportionality Kmvs between the output flow and the speed of the exit belt, where said constant can be obtained using the chute with weighing system.

And the other problem that is solved with the invention is regarding the costs of maintenance of chutes lining, of the belt belonging to the conveyor belt of exit of chute material and impact idlers that are subject to greater wear due to the blows produced by the material in the free fall on said components. And the fact that the material falls on the material means that almost zero wear of the internal lining of the chute occurs and the belt and the impact idlers of the belt located in the lower part of the chute are protected from blows by the fall of the material.

FIG. 1 shows a diagram of a normal “material transfer point”, which is basically made up of a final section of a conveyor belt, material input conveyor belt 1 that we will name with the acronym CTE, also consists of an initial section of another conveyor belt, conveyor belt of exit of material 2 that we will call with the acronym CTS, additionally to both belts the system consists of a chute 3, in addition to other elements such as: a gate 4 located at the exit of the chute material, normally manually operated 12; guards and elements to seal the interior space of the chute with respect to the exterior to it and are normally equipped with a dust collection equipment to mitigate the exit of contaminated air towards the outside of the chute.

In a conventional system FIG. 1, the material transported by the CTE 1 is poured inside the chute 3 generating a flow of material 5 that falls in free fall to the CTS belt 2, traveling a height H19 where the CTS belt 2 extracts the material from the chute to transport it to another place, where that other place can be a machine for example a crusher or a stock for example a stock pile or another conveyor belt.

The physical mechanism that explains the amount of air with suspended dust generated is the amount of potential energy that the material has at the beginning of the fall with respect to the level where it will rest and to the fact that during the fall the material picks up air and which is logical if we consider that the section of the jet remains constant during the fall and as the speed increases means that air enters the interior of the jet proportionally to the speed that it is acquiring during the fall, and when it reaches the ground this air is violently expelled from the material since all the ore load that comes behind acts like a kind of piston.

The other reason that supports the argument that a greater height in free fall of the material generates more air with suspended dust is based on observation and based on models that are used to dimension the size of dust collectors where the calculated suction air flow of the collector is a function of, among other variables, the height in free fall of the material.

1. Material transfer system in which the Chute component of said system receives material from a material supply source which enters the chute finally falling on the component located at the bottom that regulates the extraction of said material from the chute CHARACTERIZED because the system is configured so that the material that enters the chute falls on an existing live load stock of material inside the chute, whose main purpose is to reduce to a minimum the height in free fall of the material and through that mechanism reduce the air emissions contaminated with suspended dust to the outside of the chute.

2. A material transfer system according to claim 1, CHARACTERIZED in that said system consists of a method and apparatus that allow a permanent stock of live load of material inside the chute.

3. A method according to claim 2 CHARACTERIZED in that said method consists in: measuring the amount of material existing inside the chute; in the measurement of either the material inlet flow to the chute or the measurement of the material outlet flow from the chute, or both depending on the particular application; in the regulation of one of the two flows; and in mathematical calculation operations that determine the necessary correction of the input or output flow and duration of said correction in order to keep the weight of the material inside the chute as close as possible to the programmed weight (Set Point).

4. Apparatus according to claim 2 CHARACTERIZED in that the main apparatus consists in the use of components that allow: measuring the flow of material into the chute or the flow of material from the chute or both; regulate the flow of material into the chute or the flow of material from the chute; the measurement of the amount of material inside the chute; hardware that receives measurement information, performs calculations and controls the flow of either input or output; and software for said hardware.

5. Method according to claim 3 CHARACTERIZED in that said method consist of that the measurement of the amount of material existing inside the chute is performed by measuring the physical quantity “weight” of the material existing inside the chute.

6. Apparatus according to claims 4 and 5 CHARACTERIZED in that the component used for measuring the amount of material inside the chute are weight sensors of the load cell type.

7. Method according to claim 3 CHARACTERIZED in that the method consist of that the measurement of the flow of input material or the flow of output material is obtained indirectly through: the measurement of the speed of the input or output belt respectively; and of the constant of proportionality between the mass flow of material and the speed of the belt.

8. Method according to claim 1 CHARACTERIZED in that the source of material supply to the chute is a conveyor belt or a feeder.

9. Method according to claim 1 CHARACTERIZED in that the source of material supply to the chute is the output of a material processing machine in which said machines can be a crusher or a sieve.

10. Method according to claim 3 CHARACTERIZED in that the method for the regulation of the flow of input or output material consists in the regulation of the speed of the input or output belt respectively.

11. Apparatus according to claim 4 CHARACTERIZED in that the apparatus used for the variation of the belt speed is a variator of the motor rpm of said belt and in which said apparatus can be a frequency inverter.

12. Apparatus according to claims 4 and 7 CHARACTERIZED in that the apparatus used to measure the speed of the input or output belt is a belt speed sensor.

13. Method according to claim 3 CHARACTERIZED in that the mathematical calculation operations are for determining the value of the input or output mass flow to be adjusted and consist of: Obtaining the value of the derivative of the weight with respect to time and equalizing this value to the difference between the mass flow of chute input material and the mass flow of chute output material; in the calculation of the difference between the current weight and the material weight value that you want to keep constant inside the chute (Set Point); depending on the previous results and one of the mass flows of material, whether the input or output, as the case may be, and a time parameter entered for the current weight to reach the desired weight, then calculate the value of the mass flow that be adjusted so that the current weight be as close as possible to the desired weight value (Set Point).

14. Method and apparatus according to claims 10; 11 and 12 CHARACTERIZED because the speed regulation of the belt is carried out through the regulation of the motor rpm taking into account the proportionality factor between the motor rpm and the corresponding belt speed.

15. Method according to claim 3 CHARACTERIZED in that the decision of the flow to be regulated either the input or the output of the chute depends on the origin of the input flow and of the destination of the output flow.

16. Method according to claim 15 CHARACTERIZED because if the origin of the inflow comes from a stock of material and the destination is a machine then the input flow into the chute be regulated for the purpose of controlling the weight of material inside the chute.

17. Method according to claim 15 CHARACTERIZED because if the origin of the input flow comes from a machine and the destination is a stock of material then the output flow of the chute be regulated for the purpose of controlling the weight of material inside the chute.

18. Apparatus according to claim 1 CHARACTERIZED in that the component that regulates the extraction of material from the chute can be a conveyor belt or a feeder.

19. Apparatus according to claim 1 CHARACTERIZED in that the component that regulates the extraction of material from the chute can be a flow regulating device or a device that opens or closes the passage of the material.

20. Apparatus according to claim 1 CHARACTERIZED in that the component that regulates the extraction of material from the chute can be a material processing machine in which said machines can be a crusher or a sieve.

21. Method and apparatus according to claim 6 CHARACTERIZED in that the weight sensors of the load cell type are positioned in the chute supports on the supporting structure of the chute.

22. Method according to claim 7 CHARACTERIZED in that the constant of proportionality between the mass flow of input material to the chute and the speed of the input belt can be obtained through a method consisting of: setting the speed at a constant speed of the input belt and measure its value; the stop for a few seconds of the material output flow; make the measurement through the chute of the incoming mass flow; calculate the quotient between the mass input flow and the speed of the material input belt to the chute, where this procedure is valid when the feed received by the material input belt to the chute is configured so that the mass flow of the material input belt to the chute is linearly proportional to the speed of said belt.

23. Method according to claim 3 CHARACTERIZED in that the apparatus for measuring the amount of material existing inside the chute can be a level sensor.

24. Method and apparatus according to claim 3 CHARACTERIZED in that the method of regulating the flow of the chute outlet material consists in regulating the transverse section of the material outlet flow from the chute and wherein said regulation can be made by a servo gate assisted commanded and controlled at a distance.

25. Apparatus according to claim 4 CHARACTERIZED in that the hardware that controls the weight of the material inside the chute through the corresponding material flow regulation can be a PID type controller (Proportional, integral, differential) or also a PLC (Control logic programmer).

26. Method according to claim 7 CHARACTERIZED in that the constant of proportionality between the mass flow of the chute's output material and the speed of the output belt can be obtained through a procedure consisting of: setting the speed at a constant speed of the output belt and measure its value; the stop for a few seconds of the material inflow; make the measurement through the chute of the mass output flow; calculate the ratio between the mass output flow and the speed of the material output belt from the chute.
